(19) United States
(12) Patent Application Publication
(10) Pub. No.: US 2022/0375266 A1
(43) Pub. Date: Nov. 24, 2022

(54) COMPUTER-READABLE RECORDING MEDIUM STORING CONTROL PROGRAM, CONTROL METHOD, AND INFORMATION PROCESSING APPARATUS

(71) Applicant: FUJITSU LIMITED, Kawasaki-shi, Kanagawa (JP)

(72) Inventor: Ikuo Kusajima, Kawasaki (JP)

(73) Assignee: FUJITSU LIMITED, Kawasaki-shi, Kanagawa (JP)

(21) Appl. No.: 17/706,325

(22) Filed: Mar. 28, 2022

(30) Foreign Application Priority Data
May 18, 2021 (JP) 2021-083599

(51) Int. Cl. G06V 40/20; G06T 7/246; G06T 7/73

(52) U.S. Cl. CPC G06V 40/23; G06T 7/246; G06T 7/73; G06T 2207/30221; G06T 2207/30196

(57) ABSTRACT

A non-transitory computer-readable recording medium stores a control program for causing an information processing apparatus to execute a process including: detecting a person region from each frame image of two dimensional moving image data; and specifying, from among multiple tracks detected from the moving image data by the tracking, a track in which a feature value related to at least one of a geometric shape of the person region and movement of a position of the person region included in the track satisfies a predetermined condition, as a track of a person whose motion is to be detected.

### CROSS-REFERENCE TO RELATED APPLICATION

This application is based upon and claims the benefit of priority of the prior Japanese Patent Application No. 2021-83599, filed on May 18, 2021, the entire contents of which are incorporated herein by reference.

### FIELD

The embodiments discussed herein are related to a computer-readable recording medium storing a control program, a control method, and an information processing apparatus.

### BACKGROUND

Regarding motion detection of a person, a laser-based three dimensional sensing technique has been established in which a plurality of three dimensional (3D) laser sensors are used to perform skeleton recognition of a person and extract skeleton coordinates in three dimensions with an accuracy of ±1 cm. For example, such a three dimensional sensing technique is formally adopted and applied in an artistic gymnastics scoring support system by the Federation Internationale de Gymnastique. The three dimensional sensing technique is expected to be used for detecting a motion of a person over time in other sports and other fields as well.

Japanese Laid-open Patent Publication No. 2019-194857 and U.S. Patent Application Publication No. 2019/0340431 are disclosed as related art.

### SUMMARY

According to an aspect of the embodiments, a non-transitory computer-readable recording medium stores a control program for causing an information processing apparatus to execute a process including: detecting a person region from each frame image of two dimensional moving image data; and specifying, from among multiple tracks detected from the moving image data by the tracking, a track in which a feature value related to at least one of a geometric shape of the person region and movement of a position of the person region included in the track satisfies a predetermined condition, as a track of a person whose motion is to be detected.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram exemplifying a motion detection system according to an embodiment;

FIG. 2 is a diagram exemplifying a block configuration of an information processing apparatus according to some embodiments;

FIGS. 3A to 3C are diagrams illustrating exemplary tracking;

FIGS. 4A to 4C are diagrams exemplifying connection and specification of tracks according to the embodiment;

FIG. 5 is a diagram exemplifying an operation flow of track detection according to the embodiment;

FIG. 6 is a diagram illustrating an example of installation of an imaging apparatus according to the embodiment;

FIG. 7 is a diagram illustrating an exemplary display screen for supporting scoring in artistic gymnastics or the like;

FIG. 8 is a diagram illustrating an exemplary scoring support display screen including the recognition result and scoring result of a skill; and

FIG. 9 is a diagram exemplifying a hardware configuration of a computer for realizing the information processing apparatus according to the embodiment.

### DESCRIPTION OF EMBODIMENTS

For example, an image-based three dimensional sensing technique for acquiring red-green-blue (RGB) data of pixels by a complementary metal oxide semiconductor (CMOS) imager or the like may be applied by using an inexpensive camera. With recent improvement in machine-learning techniques such as deep learning, the accuracy of skeleton recognition in three dimensions from an image is improving.

As an example, in a case of detecting a motion of a person over time using an image-based three dimensional sensing technique, a person region is detected in each frame image for a plurality of pieces of moving image data obtained by taking moving images of a target person from a plurality of viewpoints, tracking of the person region is performed, and a track is generated. An image of the person region detected from a frame image of a track is inputted to a skeleton recognition model created by machine learning such as deep learning to detect a skeleton, and skeleton detection in three dimensions may be performed by synthesizing pieces of skeleton information obtained from the plurality of viewpoints.

A technique related to tracking of an object is known for this.

However, for example, in a case where a plurality of persons appear in a moving image, a track is generated for each person. For example, when tracking for a person fails, a plurality of tracks may be generated for one person. In this case, it may be desired to specify, from among the plurality of tracks, a track that corresponds to a person whose motion is to be detected.

According to one aspect, an object of the present disclosure is to specify, from among a plurality of tracks, a track that corresponds to a person whose motion is to be detected.

Hereinafter, some embodiments of the present disclosure will be described in detail with reference to the drawings. The corresponding components in a plurality of drawings are denoted by the same reference sign.

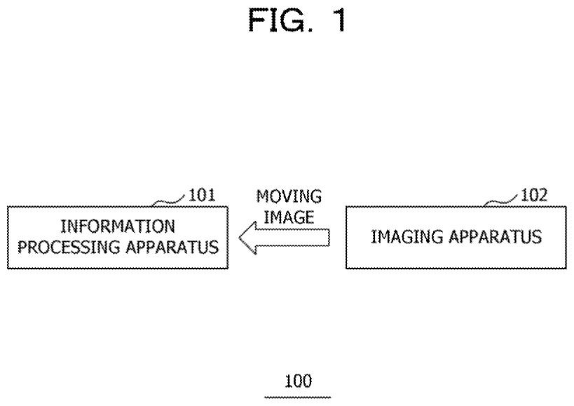

FIG. 1 is a diagram exemplifying a motion detection system 100 according to an embodiment. For example, the motion detection system 100 may include an information processing apparatus 101 and an imaging apparatus 102. For example, the information processing apparatus 101 may be a computer having a calculation function, such as a server computer, a personal computer (PC), a mobile PC, or a tablet terminal. For example, the imaging apparatus 102 may be a camera that generates two dimensional image data such as a CMOS imager.

For example, the imaging apparatus 102 takes a moving image of a person whose motion is to be detected and generates moving image data. For example, the information processing apparatus 101 may perform motion detection on the moving image data generated by the imaging apparatus 102. For example, a plurality of imaging apparatuses 102 may be installed so as to take, from a plurality of directions, moving images of a person whose motion is to be detected. For example, the information processing apparatus 101 may receive the moving image data from the imaging apparatus 102 or may acquire the moving image data generated by the imaging apparatus 102 via another apparatus.

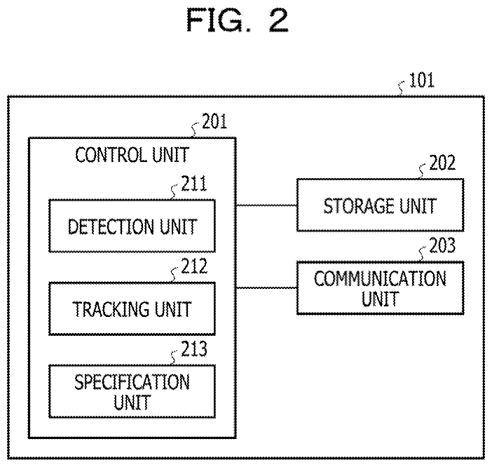

FIG. 2 is a diagram exemplifying a block configuration of the information processing apparatus 101 according to some embodiments. For example, the information processing apparatus 101 includes a control unit 201, a storage unit 202, and a communication unit 203. For example, the control unit 201 includes a detection unit 211, a tracking unit 212, a specification unit 213, and the like, and may include other functional units. For example, the storage unit 202 of the information processing apparatus 101 stores information such as moving image data generated by the imaging apparatus 102. For example, the communication unit 203 communicates with another apparatus in accordance with an instruction from the control unit 201. For example, the control unit 201 may obtain moving image data from the imaging apparatus 102 via the communication unit 203. Details of each of these units and details of information stored in the storage unit 202 will be described later.

For example, in a case where a motion of a person over time is acquired by detecting the motion of the person from a moving image for scoring of artistic gymnastics or the like, it is desirable that the motion of the person whose motion is to be detected in the moving image may be captured by tracking.

In a case of tracking a person appearing in a moving image, for example, the control unit 201 performs object detection on an image of each frame of the moving image. In an example, the control unit 201 may detect a person region from an image of each frame of a moving image by a technique based on machine learning such as deep learning. In an example, the person region may be a bounding box (BBox).

Based on the person regions detected in temporally continuous frames of the moving image, the control unit 201 tracks the motion of a target person by using a tracking technique such as multi-object tracking (MOT), and generates a track representing a time-series trajectory of the person region.

However, as described above, for example, in a case where multiple persons appear in a moving image, a track is generated for each person and multiple tracks may be detected. For example, when a track for a person fails, multiple tracks may be generated for one person. In the case where multiple tracks are generated, it may be desired to specify, from among the multiple tracks, a track that corresponds to a person whose motion is to be detected.

In this case, for example, a person whose motion is to be detected may be specified by using a physical feature or the like. As an example, a person whose motion is to be detected may be specified based on face recognition, a color of clothes, and the like. However, for example, in a case where real-time or semi-real-time processing is desired as in an artistic gymnastics scoring support system or the like, when such advanced processing as using a physical feature is performed to specify a person whose motion is to be detected, the processing may get slow. It may be difficult to use a physical feature in consideration of a privacy problem or the like. For this reason, for example, it is desired to provide a technique capable of specifying a track that corresponds to a person whose motion is to be detected when multiple tracks are generated.

According to the embodiment described below, the control unit 201 specifies, from among a plurality of tracks, a track from which a motion is to be detected, based on feature values related to at least one of the geometric shape of a person region of the track and movement of the position of the person region. Hereinafter, the embodiment will be described in more detail.

[Specification of Track from which Motion is to be Detected]

As an example, in a case where the motion of an athlete is tracked in artistic gymnastics or the like, a feature value usable for distinguishing a gymnast from another person from viewpoints such as the body type, posture, and performance of the gymnast may be set. A person whose motion is to be detected is not limited to a gymnast or the like, and may include, for example, athletes from other sports and competitions such as figure skating and dancing, and a person with other motions involving a change of his/her posture or movement of his/her position.

In an example, the control unit 201 may specify, from among a plurality of tracks, a track from which a motion is to be detected, by using feature values such as a width, a height, and an area of a person region as the feature values related to the geometric shape of the person region of the track. For example, when taking a moving image of an athlete performing gymnastics as a person whose motion is to be detected, the imaging apparatus 102 is installed such that the gymnast appears at a good position in terms of an angle of view. For this reason, for example, the person region of the gymnast is relatively large in size in the frame image.

In contrast, since a spectator or the like is not an imaging target, even when a person region of the spectator or the like is detected, the person region tends to be relatively small in size. For this reason, for example, in a case where multiple are detected, the control unit 201 may determine whether the person of a track is an athlete based on feature values related to the geometric shape such as the size of a person region included in the track, such as the vertical width, horizontal width, and area of the person region. For example, when feature values related to the size such as the vertical width, horizontal width, and area of a person region included in a track are large (for example, equal to or greater than a predetermined threshold) while satisfying a predetermined condition, the control unit 201 may determine that the track is a track from which a motion is to be detected. Alternatively, the control unit 201 may use, as feature values, statistical values such as an average value, maximum value, and minimum value of feature values related to the size such as the vertical width, horizontal width, and area of a person region included in a track. In this case, when the statistical values are large (for example, equal to or greater than a predetermined threshold) while satisfying a predetermined condition, the control unit 201 may determine that the track is a track from which a motion is to be detected.

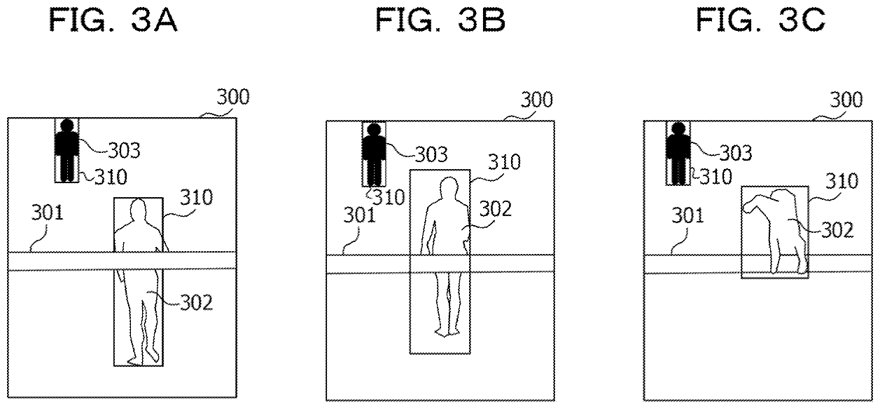

FIGS. 3A to 3C are diagrams illustrating exemplary tracking. FIGS. 3A to 3C illustrate images 300 of three consecutive frames in a moving image. A balance beam 301 and a person 302 whose motion is to be detected are included in the image 300 of each frame. In the example of FIGS. 3A to 3C, an other person 303 different from the person 302 whose motion is to be detected, is also included.

In FIG. 3A, the person 302 whose motion is to be detected and the other person 303 are detected by object detection, and person regions 310 are arranged in accordance with the respective detection positions of the persons.

Also in FIG. 3B, person regions 310 are arranged respectively in accordance with the positions of the person 302 whose motion is to be detected and the other person 303. For example, the control unit 201 may track the motion of the person 302 whose motion is to be detected and the motion of the other person 303 by comparing the person regions 310 in FIG. 3A and the person regions 310 in FIG. 3B.

Also in FIG. 3C, person regions 310 are arranged in accordance with the respective positions of the person 302 whose motion is to be detected and the other person 303. For example, the control unit 201 may track the motion of the person 302 whose motion is to be detected and the motion of the other person 303 by comparing the person regions 310 in FIG. 3B and the person regions 310 in FIG. 3C.

For example, in such a case, since the person 302 whose motion is to be detected is the imaging target, the person 302 appears in the moving image in a size larger than that of the other person 303 who is not the imaging target. For this reason, when feature values related to the geometric shape such as the size of the person region 310, such as the vertical width, horizontal width, and area of the person region 310 of a track are equal to or greater than a threshold, the control unit 201 may determine that the track is a track of a person whose motion is to be detected. In an example, when an average value of the vertical width, horizontal width, or area of the person region 310 detected from each frame image included in a track is large (for example, equal to or greater than a predetermined threshold) while satisfying a predetermined condition, the control unit 201 may determine that the track is a track of a person whose motion is to be detected.

For example, a gymnast or the like greatly changes his or her posture when performing a somersault or the like during a competition. For example, in FIG. 3C, the aspect ratio of the person region 310 of the person whose motion is to be detected greatly varies from those in FIGS. 3A and 3B. In contrast, the person region 310 of a spectator or the other person 303 who is not performing does not change because the posture does not change much. For this reason, for example, when a variation in the aspect ratio of the person region 310 of a track is large while satisfying a predetermined condition, the control unit 201 may determine that the track is a track of a person whose motion is to be detected. In an example, when the variance of the aspect ratio of the person region 310 detected from each frame image included in a track is equal to or greater than a predetermined threshold, the control unit 201 may determine that the track is a track of a person whose motion is to be detected.

For example, the control unit 201 may determine whether the person of a track is the person whose motion is to be detected, from feature values related to the movement of the position of the person region 310 in the track.

As an example, in a case where the motion of an athlete is tracked in artistic gymnastics or the like, the athlete tends to give a performance by widely using a performance area. For this reason, for example, when feature values such as a movement range of the position of the person region 310 in a track are large (for example, equal to or greater than a predetermined threshold) while satisfying a predetermined condition, the control unit 201 may determine that the person of the track is the person whose motion is to be detected. For example, when a movement range of a person region in a track in a certain axis direction in frame images is equal to or greater than a predetermined threshold, the control unit 201 may determine that the person of the track is the person whose motion is to be detected.

For example, in a case where the motion of an athlete is tracked in artistic gymnastics or the like, since the athlete repeats a high-speed motion, a stationary state, and other states during the competition, the athlete tends to give a performance while greatly changing speed. For this reason, for example, when a variation in the moving speed of the person region 310 in a track is large (for example, equal to or greater than a predetermined threshold) while satisfying a predetermined condition, the control unit 201 may determine that the person of the track is the person whose motion is to be detected. In an example, when the variance of the moving speed of the person region 310 in a track is equal to or greater than a predetermined threshold, the control unit 201 may determine that the person of the track is the person whose motion is to be detected. Alternatively, when the difference between the maximum value and the minimum value of the moving speed of the person region 310 in a track is equal to or greater than a predetermined threshold, the control unit 201 may determine that the person of the track is the person whose motion is to be detected.

For example, as described above, the control unit 201 may specify, from among—multiple tracks, a track from which a motion is to be detected, based on feature values related to the geometric shape such as the vertical width, horizontal width, area, and aspect ratio of the person region 310 included in the track. For example, the control unit 201 may specify, from among multiple tracks, a track from which a motion is to be detected, based on feature values related to the movement of the position such as the movement range and the moving speed of the person region 310 included in the track. The control unit 201 may specify, from among a plurality of tracks, a track from which a motion is to be detected, by combining feature values related to the geometric shape of the person region 310 and feature values related to the movement of the position of the person region 310. The control unit 201 may specify, from among a plurality of tracks, a track from which a motion is to be detected, by using, as feature values, statistical values such as an average value, variance, maximum value, and minimum value of the feature values related to the geometric shape and the feature values related to the movement of the position. As described above, according to the embodiment, a track that corresponds to a person whose motion is to be detected may be specified from among multiple tracks. In a case of specifying a track from which a motion is to be detected by using a plurality of feature values, the control unit 201 may give priority to determination based on any of the feature values, or may specify a track with the largest number of feature values satisfying the determination conditions as the track from which a motion is to be detected.

[Connection of Tracks]

Next, connection of tracks will be described. For example, when the motion of a person whose motion is to be detected is vigorous, detection of the person or prediction in tracking of the person may fail, and the tracking may be interrupted. As a result, multiple tracks may be generated for one person. As an example, in a case where the motion of an athlete is tracked in artistic gymnastics or the like, the posture of the person who is a tracking target and movement speed of the person change significantly. When tracking such a person whose posture and motion significantly change, the tracking may be interrupted. For example, in a case where a track is used for scoring in a competition or the like, if tracking is interrupted, the entire competition may not be scored, and thus it is desirable that tracks generated by the interrupted tracking may be connected.

In one embodiment, the control unit 201 connects a plurality of split-up tracks resulting from interrupted tracking.

In an example, for multiple tracks detected by tracking, the control unit 201 evaluates the degree of similarity between the ends of the tracks by using feature values characterizing the tracks. When the degree of similarity between two tracks is high while satisfying a predetermined condition, the control unit 201 may determine that the two tracks are tracks of the same person. In this case, for example, the control unit 201 may connect two tracks specified as tracks of the same person. In an example, when a person region at an end portion of a certain track among the plurality of tracks is similar to a person region at a start portion of another track among the multiple tracks while satisfying a predetermined condition, the control unit 201 may connect the certain track and the other track as tracks of the same person.

Accordingly, even when a track is split up, it is possible to specify and connect tracks of the same person. As a result, it is made possible to track the entire motion of a person whose motion is to be detected included in moving image data, and a track may be actively used for scoring or the like.

Hereinafter, connection of tracks will be described in more detail. For example, the control unit 201 performs object detection and tracking on a moving image and detects a track from the moving image. When multiple tracks are detected, the control unit 201 may allocate an identifier (ID) to each track for identification.

For example, a track with an i-th ID is represented by Tᵢ of Expression 1 below.

Tᵢ={x_{i,t},y_{i,t},w_{i,t},h_{i,t}}ₜ(t=t_{i,min}, . . . ,t_{i,max})

For example, x_{i, t} is an x coordinate of a center position of a person region in the frame image at time t of a track i. For example, y_{i, t} is a y coordinate of a center position of a person region in the frame image at time t of the track i. For example, w_{i, t} is the width of a person region in the frame image at time t of the track i. For example, h_{i,t} is the height of a person region in the frame image at time t of the track i. In this case, for example, the control unit 201 specifies tracks of the same person from among multiple tracks, based on these pieces of information on tracks.

For example, a start frame and an end frame of the i-th track Tᵢ are represented by t_{i, star}t and t_{i, end}, respectively. A center position of a person region in a start frame is represented by {x_{i, start}, y_{i, start}}, and a center position of a person region in an end frame is represented by {x_{i, end}, y_{i, end}}. An area of a person region in a start frame is represented by S_{i, start}, and an area of a person region in an end frame is represented by S_{i, end}.

For example, it is determined whether another track Tⱼ (j-th track) is a track of the same person with respect to a certain track Tᵢ (i-th track) selected from among the plurality of tracks. In this case, for example, the control unit 201 may extract, from among the plurality of tracks, a track including a start portion at which a time difference with respect to the end portion of the track Tᵢ is within a predetermined time. For example, the control unit 201 may extract, from among multiple tracks, a track that satisfies Expression 2 below with respect to the track Tᵢ.

|t_{i,end}−t_{j,start}|<Tₜₕ Expression 2

Tₜₕ is a constant. In an example, the control unit 201 may specify two tracks that satisfy Expression 2 above and have the smallest time difference in Expression 2 above.

Based on the information about the size and position of a person region at time t_{i, end} of the end frame of the specified i-th track and time t_{j, start} of the start frame of the specified j-th track, the control unit 201 evaluates the degree of similarity between the two tracks. In an example, the control unit 201 may calculate the degree of similarity between two tracks based on the area and the center position by using Expression 3 below, and determine that the two tracks are tracks of the same person when the degree of similarity is equal to or less than a threshold.

$$F ( {T}_{i} , {T}_{j} , {t}_{i , end} , {t}_{j , start} ) = {( {x}_{t , end} - {x}_{j , start} )}^{2} + {( {y}_{i , end} - {y}_{j , start} )}^{2} + k \vert log ( \frac{{S}_{i , end}}{{S}_{j , start}} ) \vert \qquad Expression 3$$

k is a constant.

In the above-described embodiment, after specification of two tracks with the smallest time difference in Expression 2, it is determined whether the two tracks are tracks of the same person. However, the embodiment is not limited to this. For example, in another embodiment, the control unit 201 may select two tracks as a pair from a plurality of tracks, and may determine, from among all pairs of tracks, a pair of tracks for which the degree of similarity based on Expression 3 is equal to or lower than a threshold as tracks of the same person. In still another embodiment, two tracks may be selected as a pair from among the tracks satisfying Expression 2 above, and a pair of tracks with the degree of similarity based on Expression 3 equal to or lower than a threshold or a pair of tracks with the lowest degree of similarity based on Expression 3 among all pairs may be determined as tracks of the same person.

For example, as described above, the control unit 201 may specify tracks of the same person from among multiple tracks. For example, the control unit 201 may interpolate the position of the person region 310 in a period between two tracks of the same person, and connect the two tracks.

[Specification of Optimum Timing]

The control unit 201 may specify the optimum timing for connecting two tracks specified as tracks of the same person.

For example, the control unit 201 may specify the optimum timing for connecting two tracks specified as tracks of the same person as follows. For example, the control unit 201 defines an evaluation function for evaluating the degree of similarity between person regions by using information on a person region at time t1 of the i-th track and a person region at time t2 of the j-th track.

In an example, the control unit 201 may evaluate, using Expression 4 below, the degree of similarity between the person region at time t1 of the i-th track and the person region at time t2 of the j-th track, which are determined to be person regions of the same person. In Expression 4, the control unit 201 may perform a search for the track Tᵢ with tᵢ in [t_{i, end-tk}, t_{i, end}], and specify time tᵢ at which the degree of similarity is minimized.

argminₜ_{ᵢ}_{∈[t}_{_{i,end}}₋ₜ_{ₖ}_{,t}_{_{i,end}}_{]}{F(Tᵢ,Tⱼ,tᵢ,t_{j,start})+|t_{j,start}−tᵢ|} Expression 4

The control unit 201 may use the specified time tᵢ of the i-th track at which the degree of similarity is the lowest and time t_{j, start} of the j-th track, as the optimum timing for connecting the two tracks. In Expression 4 above, a penalty term for the time difference of |t_{j, start}−tᵢ| is further added to the term of Expression 3. Accordingly, it is possible to suppress selection of a frame that is too far away.

By connecting the tracks at the optimum timing, the tracks may be smoothly connected.

For example, in a case where a track for one person is split up into a plurality of tracks, there is a possibility that some cause of tracking failure has occurred at the time of the split-up. In this case, for example, the end of the track immediately before the split-up may include an inaccurate track that does not reflect the motion of the person whose motion is to be detected. For example, even in such a case, by connecting tracks at the optimum timing as described above, the portion of an inaccurate track is removed and a track may be generated by the connection.

As an example, a track may split up when a person region of a track that has been tracking a certain person may be changed to that of another person. For example, in artistic gymnastics, an assistant may stand beside a gymnast. For example, in a case where the assistant is hidden behind the gymnast and then the assistant who has been hidden appears when the gymnast performs a somersault or the like, the person region of the gymnast may be changed to that of the assistant. For example, even in such a situation, if the assistant immediately goes outside of the angle of view, it is possible to remove the region of a track where the change has occurred by searching for the optimum timing using Expression 4 or the like.

As described above, according to the embodiment, even when a track for one person is split up into a plurality of tracks, the control unit 201 may specify tracks of the same person from among the plurality of tracks and connect the tracks. The control unit 201 may specify, from among a plurality of tracks including the track generated by the connection, a track from which a motion is to be detected.

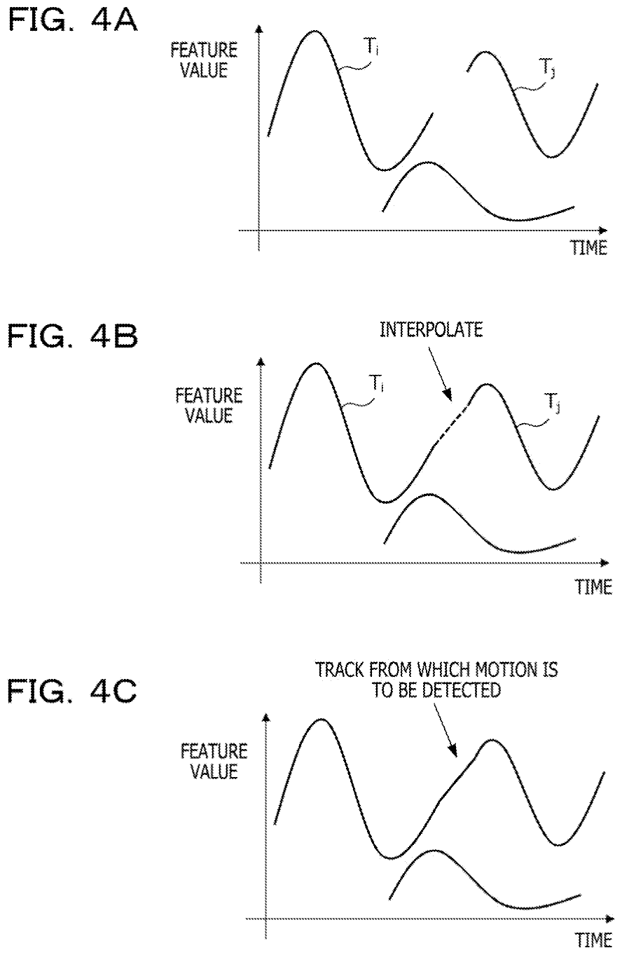

FIGS. 4A to 4C are diagrams exemplifying connection of tracks and specification of a track from which a motion is to be detected according to the embodiment. In FIGS. 4A to 4C, the vertical axis indicates a feature value of a person region. As described above, for example, the feature value may be an area, an aspect ratio, a moving speed, or the like of the person region. The horizontal axis indicates the time when a moving image is taken. As illustrated in FIG. 4B, the control unit 201 interpolates and connects the track Tᵢ and the track Tⱼ in FIG. 4A. For example, the control unit 201 may interpolate the person region in the period between two time points specified as the optimum timing such that the shapes of the person region at the two time points change linearly. In another embodiment, the control unit 201 may interpolate the person region in the period between two time points specified as the optimum timing by using a method other than linear interpolation.

As illustrated in FIG. 4C, for example, the control unit 201 may specify, from among a plurality of tracks including the track generated by the connection, a track from which a motion is to be detected, based on feature values related to at least one of the geometric shape of the person region of the track and the movement of the position of the person region.

Next, an operation flow of track detection according to the embodiment will be described.

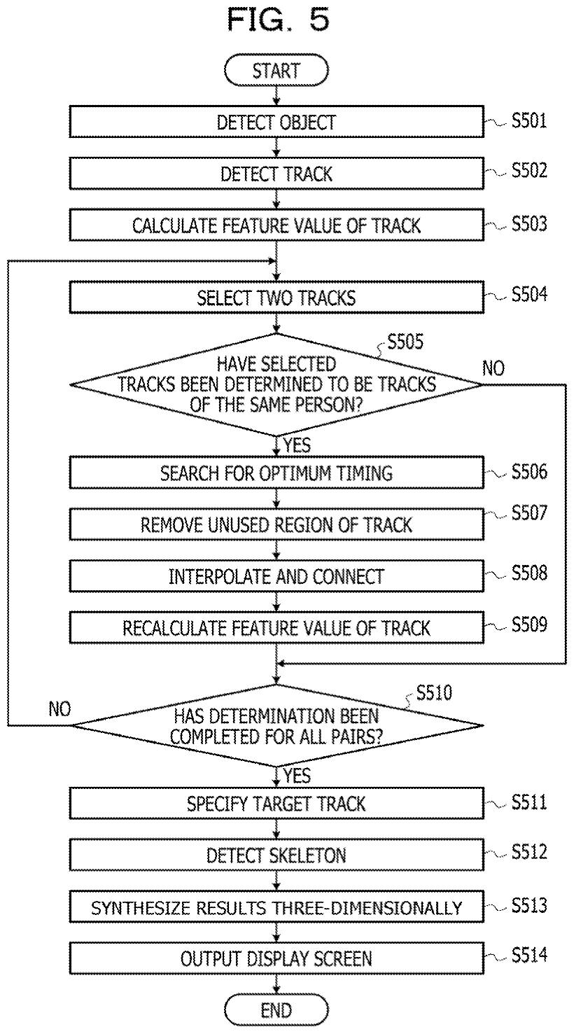

FIG. 5 is a diagram exemplifying an operation flow of track detection according to the embodiment. For example, when an instruction for motion detection is input, the control unit 201 may start the operation flow of FIG. 5. A plurality of persons including a person whose motion is to be detected may appear in moving image data from which a motion is to be detected.

In step 501 (hereinafter, step is abbreviated as “S”; for example, step 501 is referred to as S501), for example, the control unit 201 detects a person from the moving image data. For example, the control unit 201 may apply a technique of object detection to the moving image data and detect, as a person region, a region in which a person appears from the moving image data.

In S502, the control unit 201 detects a track from the moving image data. For example, the control unit 201 may perform tracking of a person by a technique such as MOT using a result of the person region detection in S501, and detect a track indicating the motion of the person. A plurality of tracks may be detected from the moving image data.

In S503, for example, the control unit 201 calculates a feature value of the track. For example, the control unit 201 may calculate a feature value related to at least one of the geometric shape of the person region included in the track and the movement of the position of the person region included in the track. Examples of the feature value related to the geometric shape of the person region include a vertical width, a horizontal width, an area, an aspect ratio, and the like of a person region in a frame image included in a track. Examples of the feature value related to the movement of the position of the person region include a movement range of the position of a person region, a moving speed of the position of a person region, and the like in frame images included in a track.

In S504, the control unit 201 selects two tracks from among a plurality of tracks detected from the moving image data. In an example, the control unit 201 may select an unselected pair of two tracks from among a plurality of pairs obtained by combining the plurality of tracks.

In S505, the control unit 201 determines whether the selected two tracks are tracks of the same person. When it is determined that the selected two tracks are not tracks of the same person (NO in S505), the flow proceeds to S510.

In contrast, when it is determined that the selected two tracks are tracks of the same person (YES in S505), the flow proceeds to S506.

In S506, the control unit 201 searches for the optimum timing for connecting the two tracks determined to be tracks of the same person. For example, the control unit 201 may specify the optimum timing for connecting the two tracks by using Expression 4 described above.

In S507, the control unit 201 removes an unused region of the track. For example, the control unit 201 may remove the region of a track between two time points specified as the optimum timing for connecting the two tracks.

In S508, the control unit 201 interpolates the person region in the period between the two time points specified as the optimum timing for connecting the two tracks, and connects the two tracks at the optimum timing.

In S509, the control unit 201 recalculates the feature value of the track. For example, in the recalculation of the feature value of the track, the control unit 201 may perform substantially the same processing as the processing of S503. Accordingly, the feature value of the track generated by connection may be acquired.

In S510, the control unit 201 determines whether the determination has been completed for all of the plurality of pairs obtained by combining the plurality of tracks. When the determination has not been completed for all of the plurality of pairs obtained by combining the plurality of tracks (NO in S510), the flow returns to S504, and the processing may be repeated by selecting an unselected pair. In an example, when tracks are connected, the control unit 201 may replace the two tracks specified as tracks of the same person from among the plurality of tracks with the track generated by the connection. For example, the control unit 201 may combine a plurality of tracks including the track generated by the connection to newly generate a plurality of pairs, and may determine whether the determination has been completed for the new plurality of pairs.

In contrast, when the determination has been completed for all of the plurality of pairs obtained by combining the plurality of tracks (YES in S510), the flow proceeds to S511.

In S511, the control unit 201 specifies, from among the plurality of tracks, a track of a person whose motion is to be detected. For example, the control unit 201 may specify, from among the plurality of tracks, a track from which a motion is to be detected, based on feature values related to at least one of the geometric shape of a person region included in the track and movement of the position of the person region included in the track.

In S512, the control unit 201 may perform skeleton detection on the person region of the track from which a motion is to be detected, and recognize the skeleton of the person whose motion is to be detected included in the moving image data.

In S513, the control unit 201 may generate a result of skeleton recognition in three dimensions of the person whose motion is to be detected, by synthesizing, using a technique of Learnable Triangulation of Human Pose or the like, the results of skeleton detection in two dimensions obtained by taking images of the person whose motion is to be detected from a plurality of directions. For example, a plurality of imaging apparatuses 102 may be installed to take moving images of the person whose motion is to be detected.

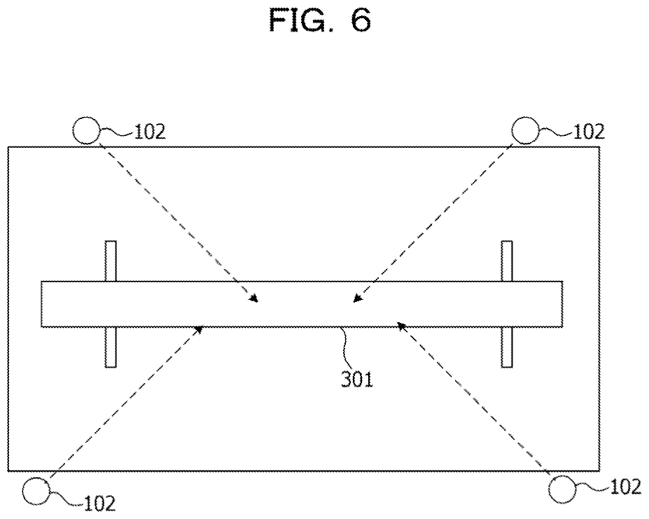

FIG. 6 is a diagram illustrating an example of installation of the imaging apparatus 102 according to the embodiment. In the example of FIG. 6, a plurality of (for example, four) imaging apparatuses 102 are installed so as to surround the balance beam 301. For example, each imaging apparatus 102 may take images from the installed position in a direction toward the balance beam 301. For example, the information processing apparatus 101 may perform the processing of S501 to the processing of S512 in FIG. 5 on the moving image data of each of the plurality of imaging apparatuses 102 to recognize the skeleton in two dimensions of the person whose motion is to be detected. In the processing of S513, the control unit 201 may generate a result of skeleton recognition in three dimensions by synthesizing the results of skeleton recognition of the pieces of moving image data generated by the plurality of imaging apparatuses 102 from a plurality of directions.

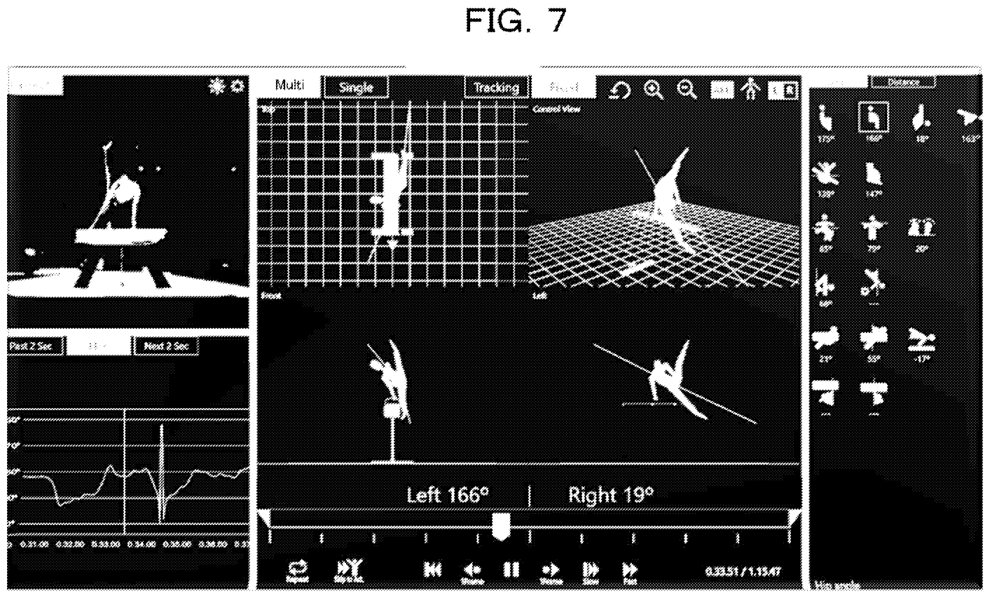

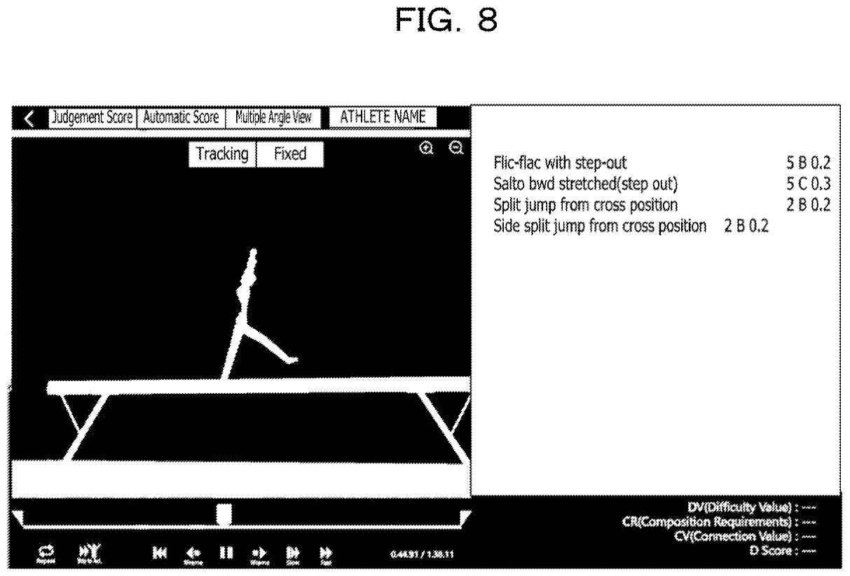

In S514, for example, based on the obtained result of skeleton recognition in three dimensions of the person whose motion is to be detected, the control unit 201 evaluates the motion of the person whose motion is to be detected, outputs display information for outputting the evaluation result to the display screen of a display device, and ends the operation flow. In an example, as illustrated in FIG. 7, the control unit 201 may output, to a display device or the like, display information for outputting a display screen for supporting scoring in artistic gymnastics or the like. Alternatively, as illustrated in FIG. 8, the control unit 201 may output, to a display device or the like, display information for outputting a scoring support screen including the recognition result and scoring result of a skill.

As described above, according to the operation flow in FIG. 5, the control unit 201 may specify a track from which a motion is to be detected from among a plurality of tracks, based on the feature of a person region included in the track.

For example, the control unit 201 may specify a track from which a motion is to be detected from among a plurality of tracks, based on the feature values related to the geometric shape of a person region.

Alternatively, for example, the control unit 201 may specify a track from which a motion is to be detected from among a plurality of tracks, based on the feature values related to the movement of the position of a person region. The control unit 201 may specify a track from which a motion is to be detected from among a plurality of tracks, based on the feature values related to the geometric shape of a person region and the feature values related to the movement of the position of the person region.

Even when a track of one person is split up into a plurality of tracks, the control unit 201 may connect the plurality of split-up tracks, based on the degree of similarity between the features of the person regions included in the tracks.

For example, in a case where a certain track and an other track are determined as tracks of the same person, the control unit 201 may search for the timing at which a person region at the end portion of the certain track is most similar to a person region at the start portion of the other track, and connect the certain track and the other track at the most similar timing. The certain track may be a track located before the other track in terms of time in moving image data.

Although embodiments have been exemplified above, the embodiments are not limited thereto. For example, the operation flow described above is an exemplified one, and the embodiment is not limited thereto. The order of processing in the operation flow may be changed if possible, the operation flow may further include another processing, or part of processing may be omitted. For example, the processing of S513 and the processing of S514 in FIG. 5 may be separately performed, in which case the processing of S513 and the processing S514 do not have to be performed in FIG. 5.

In the above-described embodiments, for example, the control unit 201 operates as the detection unit 211 in the processing of S501. For example, the control unit 201 operates as the tracking unit 212 in the processing of S502. For example, the control unit 201 operates as the specification unit 213 in the processing of S511.

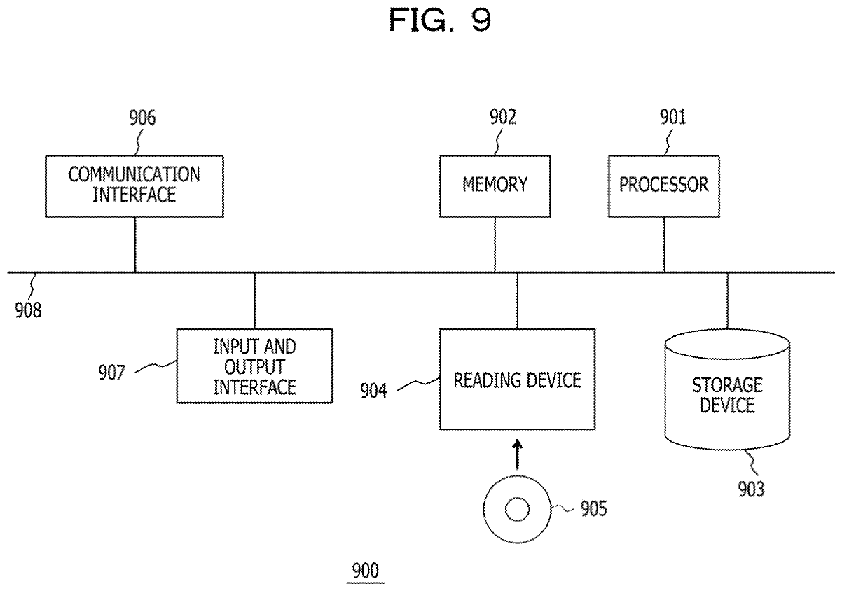

FIG. 9 is a diagram exemplifying a hardware configuration of a computer 900 for realizing the information processing apparatus 101 according to the embodiment. For example, the hardware configuration for realizing the information processing apparatus 101 in FIG. 9 includes a processor 901, a memory 902, a storage device 903, a reading device 904, a communication interface 906, and an input and output interface 907. For example, the processor 901, the memory 902, the storage device 903, the reading device 904, the communication interface 906, and the input and output interface 907 are coupled to each other via a bus 908.

For example, the processor 901 may be a single processor, a multiprocessor, or a multicore processor. For example, the processor 901 executes, using the memory 902, a program in which the procedure of the above-described operation flow is described, thereby providing some or all of the functions of the above-described units. For example, by reading and executing a program that is stored in the storage device 903, the processor 901 of the information processing apparatus 101 functions as the detection unit 211, the tracking unit 212, and the specification unit 213.

For example, the memory 902 is a semiconductor memory and may include a RAM area and a ROM area. For example, the storage device 903 is a hard disk drive, a semiconductor memory such as a flash memory, or an external storage device. RAM is an abbreviation for a random-access memory. ROM is an abbreviation for a read-only memory.

The reading device 904 accesses a removable storage medium 905 in accordance with an instruction of the processor 901. For example, the removable storage medium 905 is realized by a semiconductor device, a medium to and from which information is input and output by a magnetic action, a medium to and from which information is input and output by an optical action, or the like. For example, the semiconductor device is a Universal Serial Bus (USB) memory. For example, the medium to and from which information is input and output by a magnetic action is a magnetic disk. For example, the medium to and from which information is input and output by an optical action is a CD-ROM, a DVD, a Blu-ray Disc (Blu-ray is a registered trademark), or the like. CD is an abbreviation for a compact disc. DVD is an abbreviation for a Digital Versatile Disk.

For example, the storage unit 202 includes the memory 902, the storage device 903, and the removable storage medium 905. For example, information such as moving image data generated by the imaging apparatus 102 is stored in the storage device 903 of the information processing apparatus 101.

The communication interface 906 communicates with another apparatus in accordance with an instruction from the processor 901. For example, the information processing apparatus 101 may receive moving image data from the imaging apparatus 102 via the communication interface 906. The communication interface 906 is an example of the communication unit 203 described above.

For example, the input and output interface 907 may be an interface between an input device and the information processing apparatus 101 and between an output device and the information processing apparatus 101. For example, the input device is a device such as a keyboard, a mouse, or a touch panel that receives an instruction from a user. For example, the output device is a display device such as a display and an audio device such as a speaker.

For example, each program according to the embodiment is provided to the information processing apparatus 101 as follows:

(1) the program is installed in advance, in the storage device 903;

(2) the program is provided by the removable storage medium 905; or

(3) the program is provided from a server such as a program server.

The hardware configuration of the computer 900 for realizing the information processing apparatus 101 described with reference to FIG. 9 is an exemplified one, and the embodiment is not limited thereto. For example, a part of the above-described configuration may be removed, or a new configuration may be added. In another embodiment, for example, some or all of the functions of the control unit 201 described above may be implemented as hardware such as an FPGA, an SoC, an ASIC, a PLD, or the like. FPGA is an abbreviation for a field-programmable gate array. SoC is an abbreviation for a system-on-a-chip. ASIC is an abbreviation for an application-specific integrated circuit. PLD is an abbreviation for a programmable logic device.

Some embodiments have been described above. However, the embodiments are not limited to the above-described embodiments. It is to be understood that the embodiments include various variations and alternatives of the above-described embodiments. For example, it would be understood that various embodiments are able to be embodied by modifying the elements without departing from the gist and the scope of the embodiments. It would also be understood that various embodiments are able to be implemented by appropriately combining a plurality of the elements disclosed according to the above-described embodiment. Also, one skilled in the art would understand that various embodiments are able to be implemented by removing some elements from the elements described according to the embodiment or by adding some elements to the elements described according to the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a control program for causing an information processing apparatus to execute a process, the process comprising:
detecting a person region from each frame image of two dimensional moving image data; and
specifying, from among multiple tracks detected from the moving image data by the tracking, a track in which a feature value related to at least one of a geometric shape of the person region and movement of a position of the person region included in the track satisfies a predetermined condition, as a track of a person whose motion is to be detected.

2. The non-transitory computer-readable recording medium according to claim 1,
wherein the predetermined condition includes that an area of the person region included in the track is large while satisfying a predetermined condition.

3. The non-transitory computer-readable recording medium according to claim 1,
wherein the predetermined condition includes that a variation in an aspect ratio of the person region included in the track is large while satisfying a predetermined condition.

4. The non-transitory computer-readable recording medium according to claim 1,
wherein the predetermined condition includes that a movement range of a position of the person region included in the track is large while satisfying a predetermined condition.

5. The non-transitory computer-readable recording medium according to claim 1,
wherein the predetermined condition includes that a variation in a moving speed of the person region included in the track is large while satisfying a predetermined condition.

6. The non-transitory computer-readable recording medium according to claim 1, the process further comprising:
connecting a certain track among the multiple tracks and an other track among the multiple tracks when a person region at an end portion of the certain track is similar to a person region at a start portion of the other track while satisfying a predetermined condition.

7. The non-transitory computer-readable recording medium according to claim 6,
wherein the connecting includes searching for most similar timing at which the person region at the end portion of the certain track is most similar to the person region at the start portion of the other track, and connecting the certain track and the other track at the most similar timing.

8. A control method comprising:
detecting, by a computer, a person region from each frame image of two dimensional moving image data; and
specifying, from among multiple tracks detected from the moving image data by the tracking, a track in which a feature value related to at least one of a geometric shape of the person region and movement of a position of the person region included in the track satisfies a predetermined condition, as a track of a person whose motion is to be detected.

9. An information processing apparatus comprising:
a memory; and
a processor coupled to the memory and configured to:
detect a person region from each frame image of two dimensional moving image data; and
specify, from among multiple tracks detected from the moving image data by the tracking, a track in which a feature value related to at least one of a geometric shape of the person region and movement of a position of the person region included in the track satisfies a predetermined condition, as a track of a person whose motion is to be detected.
